(19) United States
(12) Patent Application Publication
(10) Pub. No.: US 2013/0336129 A1
(43) Pub. Date: Dec. 19, 2013

(54) Multipurpose Use of Delay Measurement Message Buffer for Software Processing of Delay Measurement Response

(71) Applicants: Kumar Shanmugam, Pearl River, NY (US); Jian-lin Mu, Ramsey, NJ (US); Nitin Gogate, Montvale, NJ (US); Zafrir Babin, Glen Rock, NJ (US); Muhammad Sawar, Brookfield, CT (US); Basavaraj Menasinahal, Montvale, NJ (US); RakeshKumar Patel, Emerson, NJ (US); Zigmunds Andis Putnins, Ridgewood, NJ (US)

(72) Inventors: Kumar Shanmugam, Pearl River, NY (US); Jian-lin Mu, Ramsey, NJ (US); Nitin Gogate, Montvale, NJ (US); Zafrir Babin, Glen Rock, NJ (US); Muhammad Sawar, Brookfield, CT (US); Basavaraj Menasinahal, Montvale, NJ (US); RakeshKumar Patel, Emerson, NJ (US); Zigmunds Andis Putnins, Ridgewood, NJ (US)

(73) Assignee: FUJITSU LIMITED, Kanagawa (JP)

(21) Appl. No.: 13/524,772

(22) Filed: Jun. 15, 2012

(51) Int. Cl. H04L 12/26

(52) U.S. Cl. 370/241.1

(57) ABSTRACT

In accordance with the present disclosure, a method may include receiving a delay measurement message frame at a responder maintenance end point from a controller maintenance end point. The method may further include writing an ingress time value to the delay measurement message frame upon receipt of the delay measurement message at the responder maintenance end point. The method may also include generating a delay measurement response frame based on the delay measurement message frame, the delay measurement response frame comprising an egress timestamp field having a value equal to the difference between a time at which the delay measurement response frame is transmitted from the responder maintenance end point and a time represented by the ingress time value. The method may additionally include transmitting the delay measurement response from the responder maintenance end point to the controller maintenance end point.

### TECHNICAL FIELD

This invention relates generally to the field of communications systems and more specifically to multipurpose use of a delay measurement message buffer for software processing of a delay measurement response.

### BACKGROUND

A communication network may include network elements that route packets through the network. Some network elements may include a distributed architecture, wherein packet processing may be distributed among several subsystems of the network element (e.g., line cards). Service Operation, Administration, and Management (“Service OAM” or “SOAM”), is defined by ITU-T Y.1731/IEEE 802.1ag and defines Maintenance Entity Group End Points (MEPs) that may be provisioned on a network element. A MEP may be associated with a particular maintenance level (e.g., 0 to 7) and may be configured to communicate management traffic, for example continuity check messages (CCMs), delay measurement messages (DMMs), and delay management responses (DMRs) to a peer MEP at the same maintenance level that resides in the communication network.

In accordance with relevant standards, a DMM frame may be communicated from one MEP (a controller MEP) to another MEP (a responder MEP) which in turn may respond with a DMR frame. The DMR frame may include timestamps indicative of the ingress time of the DMM at the responder MEP and the egress time of the DMR from the responder MEP, such that the controller MEP may determine a round-trip delay based on its time of receipt of the DMR frame along with timestamps present in the DMR frame.

While some approaches have provided for processing of DMR frames in hardware, such hardware-based solutions may not be preferable due to increased cost and/or design complexity. In addition, known approaches to software processing of DMR frames may be undesirable, as they may introduce unaccounted-for delays from software processing before the ingress timestamp is written and after the egress of the frames, which may be included in the delay measurements and may lead to inaccurate results. In addition, Interrupt Service Routine (ISR) driven packet processing in software may be best suited to perform ingress and egress timestamping, but ISR may not be feasible, as such processing may be complex and require memory allocation to store data for time stamps.

### SUMMARY OF THE DISCLOSURE

In accordance with the present disclosure, disadvantages and problems associated with processing of delay measurement responses may be reduced or eliminated.

In accordance with the present disclosure, a method may include receiving a delay measurement message frame at a responder maintenance end point from a controller maintenance end point. The method may further include writing an ingress time value to the delay measurement message frame upon receipt of the delay measurement message at the responder maintenance end point. The method may also include generating a delay measurement response frame based on the delay measurement message frame, the delay measurement response frame comprising an egress timestamp field having a value equal to the difference between a time at which the delay measurement response frame is transmitted from the responder maintenance end point and a time represented by the ingress time value. The method may additionally include transmitting the delay measurement response from the responder maintenance end point to the controller maintenance end point.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates a block diagram of an example communication network, in accordance with embodiments of the present disclosure;

FIG. 2 illustrates a block diagram an example network element, in accordance with embodiments of the present disclosure;

FIG. 3 illustrates various fields of a DMM frame and a DMR frame as such frames are processed by a maintenance end point, in accordance with embodiments of the present disclosure; and

FIG. 4 illustrates a block diagram of a delay measurement responder of a maintenance end point processing a DMM frame and to generate a DMR frame, in accordance with embodiments of the present disclosure.

### DETAILED DESCRIPTION OF THE DRAWINGS

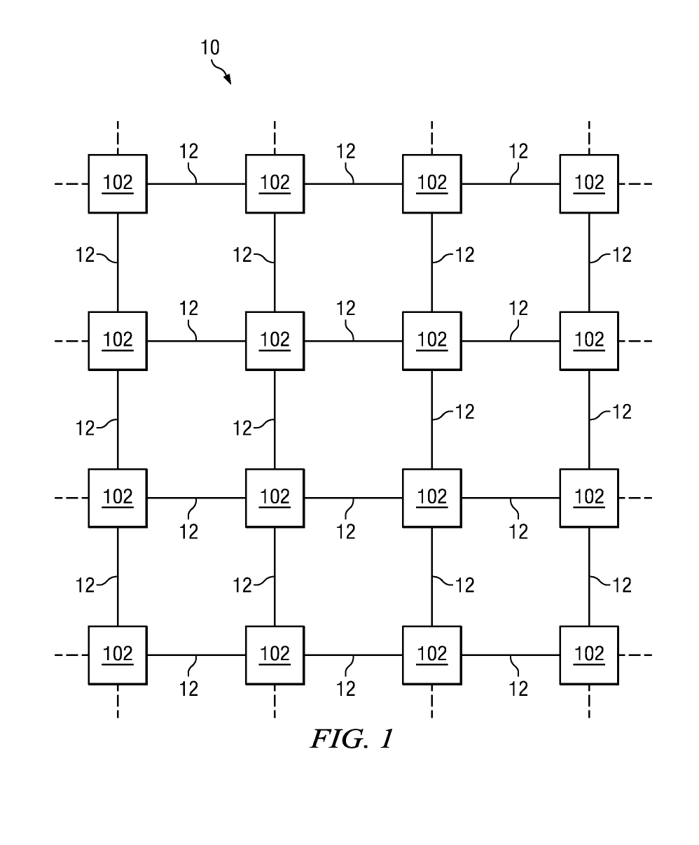

Embodiments of the present invention and its advantages are best understood by referring to FIGS. 1-4, like numerals being used for like and corresponding parts of the various drawings.

FIG. 1 illustrates a block diagram of an example network 10, in accordance with embodiments of the present disclosure. In certain embodiments, network 10 may be an Ethernet network. Network 10 may include one or more transmission media 12 operable to transport one or more signals communicated by components of network 10. The components of network 10, coupled together by transmission media 12, may include a plurality of network elements 102. In the illustrated network 10, each network element 102 is coupled to four other nodes. However, any suitable configuration of any suitable number of network elements 102 may create network 10. Although network 10 is shown as a mesh network, network 10 may also be configured as a ring network, a point-to-point network, or any other suitable network or combination of networks. Network 10 may be used in a short-haul metropolitan network, a long-haul inter-city network, or any other suitable network or combination of networks.

Each transmission medium 12 may include any system, device, or apparatus configured to communicatively couple network devices 102 to each other and communicate information between corresponding network devices 102. For example, a transmission medium 12 may include an optical fiber, an Ethernet cable, a T1 cable, a WiFi signal, a Bluetooth signal, or other suitable medium.

Network 10 may communicate information or “traffic” over transmission media 12. As used herein, “traffic” means information transmitted, stored, or sorted in network 10. Such traffic may comprise optical or electrical signals configured to encode audio, video, textual, and/or any other suitable data. The data may also be real-time or non-real-time. Traffic may be communicated via any suitable communications protocol, including, without limitation, the Open Systems Interconnection (OSI) standard and Internet Protocol (IP). Additionally, the traffic communicated in network 10 may be structured in any appropriate manner including, but not limited to, being structured in frames, packets, or an unstructured bit stream.

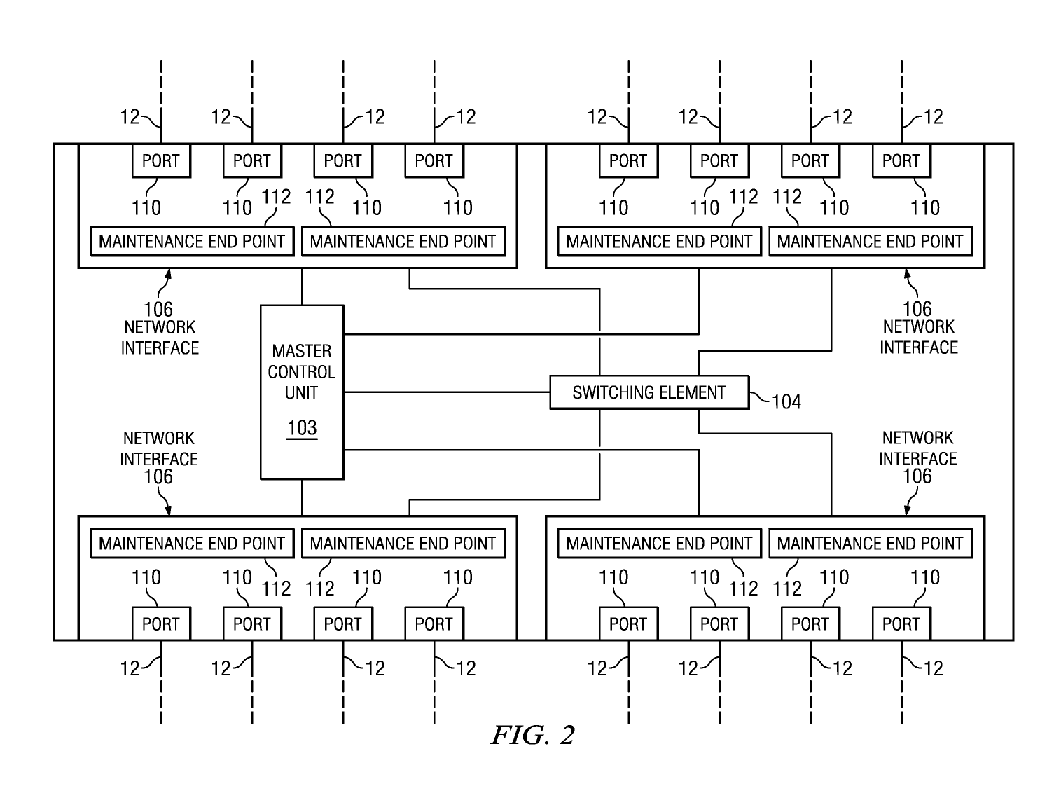

Each network element 102 in network 10 may comprise any suitable system operable to transmit and receive traffic. In the illustrated embodiment, each network element 102 may be operable to transmit traffic directly to one or more other network elements 102 and receive traffic directly from the one or more other network elements 102. Network elements 102 will be discussed in more detail below with respect to FIG. 2.

Modifications, additions, or omissions may be made to network 10 without departing from the scope of the disclosure. The components and elements of network 10 described may be integrated or separated according to particular needs. Moreover, the operations of network 10 may be performed by more, fewer, or other components.

FIG. 2 illustrates a block diagram an example network element 102, in accordance with embodiments of the present disclosure. As discussed above, each network element 102 may be coupled to one or more other network elements 102 via one or more transmission media 12. Each network element 102 may generally be configured to receive data from and/or transmit data to one or more other network elements 102. In certain embodiments, network element 102 may comprise a switch configured to route data received by network element 102 to another device (e.g., another network element 102) coupled to network element 102.

As depicted in FIG. 2, each network element 102 may include a master control unit 103, a switching element 104, and one or more network interfaces 106 communicatively coupled to each of master control unit 103 and switching element 104.

Master control unit 103 may include any suitable system, apparatus, or device configured to manage network element 102, including management of routing of data between ports 110. Master control unit 103 may maintain a routing table in accordance with open shortest path first (OSPF) protocol, intermediate system-intermediate system (ISIS) protocol, or any other suitable protocol, wherein such routing table may include any table, database, file, or other data structure configured to maintain information relating a particular ingress port 110 to a corresponding egress port 110.

Switching element 104 may be communicatively coupled to master control unit 103 and may include any suitable system, apparatus, or device configured to receive traffic via a port 110 and route such traffic to a particular network interface 106 and/or port 110 based on analyzing the contents of the data and/or based on a characteristic of a signal carrying the data (e.g., a wavelength and/or modulation of the signal). For example, in certain embodiments, a switching element 104 may include a switch fabric (SWF).

Each network interface 106 may include any suitable system, apparatus, or device configured to serve as an interface between a network element 102 and a transmission medium 12. Each network interface 106 may enable its associated network element 102 to communicate to other network elements 102 using any suitable transmission protocol and/or standard. Network interface 106 and its various components may be implemented using hardware, software, or any combination thereof. For example, in certain embodiments, one or more network interfaces 106 may include a network interface card. In the same or alternative embodiments, one or more network interfaces 106 may include a line card.

As depicted in FIG. 2, each of network interfaces 106 may include one or more physical ports 110. Each physical port 110 may include any system, device or apparatus configured to serve as a physical interface between a corresponding transmission medium 12 and network interface 106. For example, a physical port 110 may comprise an Ethernet port, an optical port, or any other suitable port.

Also as shown in FIG. 2, each network interface 106 may have one or more maintenance end points 112 provisioned thereon. A maintenance end point 112 may include an end point of a group of network components associated with a particular maintenance level and may be configured to process and communicate management traffic to a peer maintenance end point 112 of the same maintenance level. Such management traffic may include heartbeat or hello messages (e.g., CCMs), delay measurement messages (DMMs), delay measurement responses (DMRs), loopback messages, linktrace messages, and alarm indication signal messages. In certain embodiments, a maintenance end point 112 may include a Maintenance Entity Group End Point (MEP) in accordance with a SOAM standard (e.g., ITU-T Y.1731/IEEE 802.1ag). Although network element 102 is depicted in FIG. 2 as having a particular number of maintenance end points 112, network element 102 may include any suitable number of maintenance end points 112. In some embodiments, network element 102 may include a plurality of maintenance end points 112 wherein at least two of such maintenance end points 112 are of a different maintenance level.

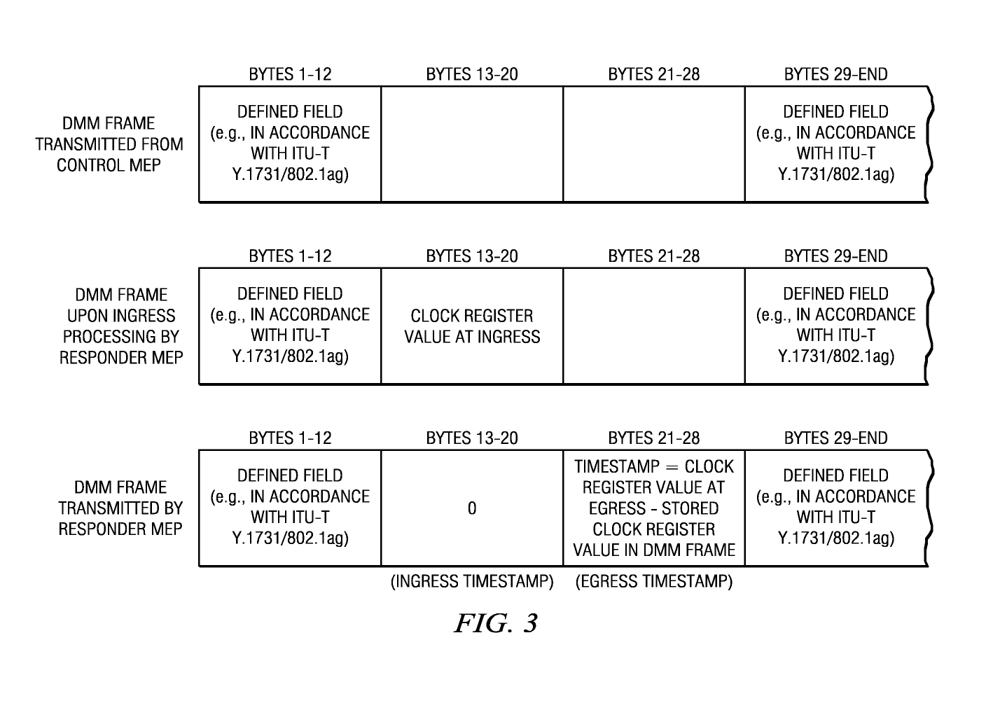

FIG. 3 illustrates various fields of a DMM frame and a DMR frame as such frames are processed by a maintenance end point 112, in accordance with embodiments of the present disclosure. As shown in FIG. 3, as a DMM frame is transmitted from a control maintenance end point 112, such frame may include specified fields, including reserved or empty fields. For example, in accordance with ITU-T Y.1731/IEEE 802.1ag, a DMM may have empty fields (e.g., in byte positions 13-28) which are reserved for timestamp information in a DMR frame.

Upon receipt of the DMM frame by a responder maintenance end point 112, the responder maintenance end point 112 may store a value in the otherwise empty reserved fields of the DMM frame (e.g. byte positions 13-20) indicative of a time in which the DMM frame ingresses to the responder maintenance end point 112. Such value may be equal to the value of a clock register associated with the responder MEP. As described below, such value may be stored in the DMM frame by an Interrupt Service Routine (ISR) of the responder maintenance end point 112. It may be desirable to perform time stamping using ISR, as it may avoid inclusion of software delays in delay measurements.

During generation of the DMR frame in response to the DMM frame, the responder MEP may, in accordance with applicable standards, write an ingress timestamp and an egress timestamp to the DMR frame. The ingress timestamp may be written (e.g., at byte positions 13-20) to have a value of 0, while the egress timestamp may written (e.g., at byte positions 21-28) to be a value equal to a time of egress of the DMR from the responder maintenance end point 112 (e.g., a present value of the clock register associated with the responder MEP upon completion of processing) minus the time value stored in the DMM frame. Thus, the difference between the egress timestamp and ingress timestamp will be indicative of the difference in time between ingress of the DMM frame and egress of the DMR frame. In some embodiments, values for the ingress timestamp and/or the egress timestamp may be stored in accordance with IEEE 1588-2002 format.

Although FIG. 3 shows various fields as being positioned in a particular location with a DMM or DMR frame, and having particular lengths, it is understood that such fields may be of any size and may be positioned at any suitable location with a DMM or DMR frame.

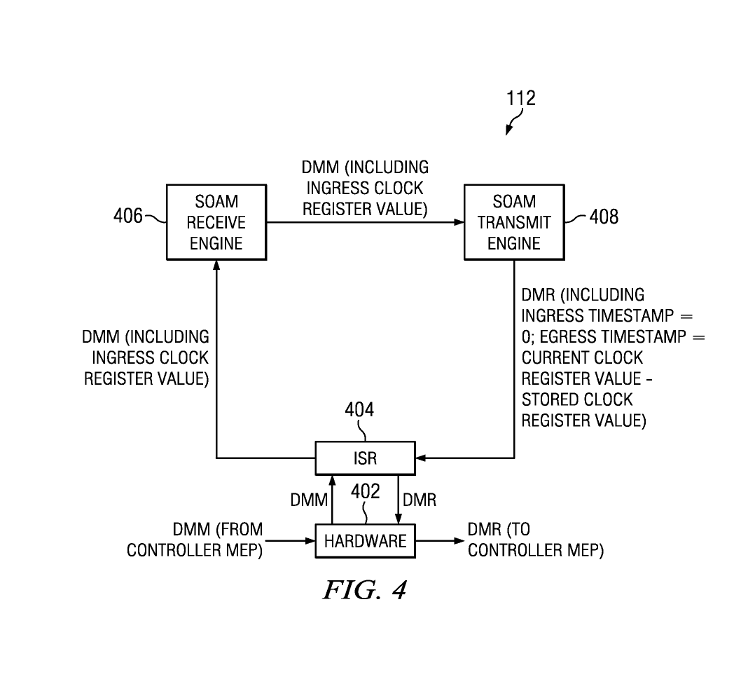

FIG. 4 illustrates a block diagram of DMM frame and DMR frame processing in a maintenance end point 112, in accordance with embodiments of the present disclosure. As shown in FIG. 4, a DMM communicated from a controller maintenance end point 112 may ingress on hardware 402 (e.g., a network interface card 106, port 110, chipset, etc.) associated with a responder maintenance end point 112. An Interrupt Service Routine (ISR) 404 of the of the responder maintenance end point 112 may receive the DMM and write a value to the DMM indicative of a time of ingress of the DMM, as described above. A SOAM Receive Engine 406 of the responder maintenance end point 112 may perform verification and/or validation of the DMM, and a SOAM Transmit Engine 408 of the maintenance end point 112 may generate a DMR, including an ingress timestamp field having a value of 0 and an egress timestamp field having a value equal to the difference between a time at which processing of the DMR by SOAM transmit engine has completed and the time of ingress represented by the value written to the DMM. ISR may complete processing by communicating the DMR to hardware 402, which may in turn transmit the DMR to the controller maintenance end point 112 originating the DMM.

Is noted that the various timestamps reflecting ingress and egress written to DMM and DMR frames, as discussed herein, may not be the exact times of ingress or egress or may not be the exact time between ingress and egress due to limitations in processing.

The methods and system disclosed herein may be advantageous in that they provide a software-based solution to DMR processing, while not requiring complex memory allocation. Memory allocation for the DMM and DMR frames is generally inherent, thus no data structure for storing timestamps and thus no additional memory associated with such data structure are needed, as timestamps are stored in data overhead already allocated for DMM and DMR frames.

A component of network 10 may include an interface, logic, memory, and/or other suitable element. An interface receives input, sends output, processes the input and/or output, and/or performs other suitable operation. An interface may comprise hardware and/or software.

Logic performs the operations of the component, for example, executes instructions to generate output from input. Logic may include hardware, software, and/or other logic. Logic may be encoded in one or more tangible computer readable storage media and may perform operations when executed by a computer. Certain logic, such as a processor, may manage the operation of a component. Examples of a processor include one or more computers, one or more microprocessors, one or more applications, and/or other logic.

A memory stores information. A memory may comprise one or more tangible, computer-readable, and/or computer-executable storage medium. Examples of memory include computer memory (for example, Random Access Memory (RAM) or Read Only Memory (ROM)), application specific integrated circuit (ASIC), field-programmable gate array (FPGA), mass storage media (for example, a hard disk), removable storage media (for example, a Compact Disk (CD) or a Digital Video Disk (DVD)), database and/or network storage (for example, a server), and/or other computer-readable medium.

Modifications, additions, or omissions may be made to network 10 and its various components without departing from the scope of the invention. The components of network 10 may be integrated or separated. Moreover, the operations of network 10 may be performed by more, fewer, or other components. Additionally, operations of network 10 and its various components may be performed using any suitable logic. As used in this document, “each” refers to each member of a set or each member of a subset of a set.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could me made hereto without departing from the spirit and scope of the invention.

What is claimed is:

1. A method comprising:
receiving a delay measurement message frame at a responder maintenance end point from a controller maintenance end point;
writing an ingress time value to the delay measurement message frame upon receipt of the delay measurement message at the responder maintenance end point;
generating a delay measurement response frame based on the delay measurement message frame, the delay measurement response frame comprising an egress timestamp field having a value equal to the difference between a time at which the delay measurement response frame is transmitted from the responder maintenance end point and a time represented by the ingress time value; and
transmitting the delay measurement response from the responder maintenance end point to the controller maintenance end point.

2. The method of claim 1, wherein writing the ingress time value to the delay measurement message frame comprises writing the ingress time value to a reserved field of the delay measurement message frame.

3. The method of claim 1, wherein the ingress time value is equal to a clock register value associated with the responder maintenance end point at the time of receipt of the delay measurement message at the responder maintenance end point.

4. The method of claim 1, wherein each of the controller maintenance end point and the responder maintenance end point is a Maintenance Entity Group End Point in accordance with ITU-T Y.1731/IEEE 802.1ag.

5. The method of claim 1, wherein the delay measurement response frame further comprises an ingress timestamp field having a value of zero.

6. The method of claim 1, wherein the value of the egress timestamp field is in IEEE 1588-2002 format.

7. The method of claim 1, wherein each of the time at which the delay measurement response frame is transmitted from the responder maintenance end point and the time represented by the ingress time value is based on a clock register value associated with the responder maintenance end point.

8. A network element comprising:
a switching element; and
a network interface having instantiated thereon a maintenance end point, the maintenance end point configured to:
receive a delay measurement message frame from a controller maintenance end point;
write an ingress time value to the delay measurement message frame upon receipt of the delay measurement message;
generate a delay measurement response frame based on the delay measurement message frame, the delay measurement response frame comprising an egress timestamp field having a value equal to the difference between a time at which the delay measurement response frame is transmitted from the maintenance end point and a time represented by the ingress time value; and
transmit the delay measurement response from the maintenance end point to the controller maintenance end point.

9. The network element of claim 8, the maintenance end point configured to write the ingress time value to the delay measurement message frame by writing the ingress time value to a reserved field of the delay measurement message frame.

10. The network element of claim 8, wherein the ingress time value is equal to a clock register value associated with the network endpoint at the time of receipt of the delay measurement message at the responder maintenance end point.

11. The network element of claim 8, wherein each of the controller maintenance end point and the maintenance end point is a Maintenance Entity Group End Point in accordance with ITU-T Y.1731/IEEE 802.1ag.

12. The network element of claim 8, wherein the delay measurement response frame further comprises an ingress timestamp field having a value of zero.

13. The network element of claim 8, wherein the value of the egress timestamp field is in IEEE 1588-2002 format.

14. The network element of claim 8, wherein each of the time at which the delay measurement response frame is transmitted from the maintenance end point and the time represented by the ingress time value is based on a clock register value associated with the maintenance end point.

15. A system comprising:
logic for receiving a delay measurement message frame at a responder maintenance end point from a controller maintenance end point;
logic for writing an ingress time value to the delay measurement message frame upon receipt of the delay measurement message at the responder maintenance end point;
logic for generating a delay measurement response frame based on the delay measurement message frame, the delay measurement response frame comprising an egress timestamp field having a value equal to the difference between a time at which the delay measurement response frame is transmitted from the responder maintenance end point and a time represented by the ingress time value; and
logic for transmitting the delay measurement response from the responder maintenance end point to the controller maintenance end point.

16. The system of claim 15, the logic for writing an ingress time value to the delay measurement message frame comprising logic for writing the ingress time value to a reserved field of the delay measurement message frame.

17. The system of claim 15, wherein the ingress time value is equal to a clock register value associated with the network endpoint at the time of receipt of the delay measurement message at the responder maintenance end point.

18. The system of claim 15, wherein each of the controller maintenance end point and the responder maintenance end point is a Maintenance Entity Group End Point in accordance with ITU-T Y.1731/IEEE 802.1ag.

19. The system of claim 15, wherein the delay measurement response frame further comprises an ingress timestamp field having a value of zero.

20. The system of claim 15, wherein the value of the egress timestamp field is in IEEE 1588-2002 format.

21. The system of claim 15, wherein each of the time at which the delay measurement response frame is transmitted from the responder maintenance end point and the time represented by the ingress time value is based on a clock register value associated with the responder maintenance end point.
